(19) United States
(12) Patent Application Publication
(10) Pub. No.: US 2019/0168432 A1
(43) Pub. Date: Jun. 6, 2019

(54) METHOD AND DEVICE FOR HEATING A MOULD

(71) Applicant: ROCTOOL, LE BOURGET DU LAC (FR)

(72) Inventor: JOSÉ FEIGENBLUM, SAINT PAUL (FR)

(21) Appl. No.: 16/098,859

(22) PCT Filed: May 10, 2017
(86) PCT No.: PCT/EP2017/061239

§ 371 Date: Feb. 19, 2019

(30) Foreign Application Priority Data
May 10, 2016 (FR) 1670219

(51) Int. Cl. B29C 45/73; B29C 33/06; B29C 35/08; B29C 35/16

(52) U.S. Cl. CPC B29C 45/73; B29C 33/06; B29C 35/0805; B29C 2045/7393; B29C 2035/0811; B29C 2035/1616; B29C 2045/7368; B29C 35/16

(57) ABSTRACT

A mold, particularly for injection molding, includes a shell defining a cavity delimiting a molding surface, a heat accumulator and inductor heater, configured to heat the heat accumulator. A receiving surface, which is a part of a surface of the shell other than the molding surface, is either exposed to or shielded from the heat of heat accumulator, to bring the entire molding surface to a predetermined temperature to inject the material into the cavity.

The invention relates to a method and a device for heating a mould. The invention is more particularly but not exclusively suitable for heating a plastic injection mould. Such a mould comprises a moulding cavity inside which the molten plastic material is injected. Said cavity is delimited by moulding surfaces, the shape of which is reproduced by the moulded part. Said moulding surfaces are supported by a least two shells that can be separated from each other so as to open the mould and remove the solidified part.

A thermal cycle is performed on the moulding cavity during the moulding operation, so that the temperature of said cavity is high enough so that the injected material remains fluid and fills the cavity correctly. The temperature is then reduced, if necessary by forced cooling, so as to solidify the part, until the mould is opened and the part removed from the mould, when the temperature of the moulding surfaces reduces before being warmed up again and restarting the cycle. Thus, the cycle time that is a particularly critical parameter in a large series situation, is dictated by heating and cooling times of the moulding cavity. The quality of the parts obtained and particularly their appearance depends on the ability to achieve a uniform temperature distribution on moulding surfaces of the cavity, and under some circumstances the structural quality of the parts obtained depends on heating and cooling rates of the moulded material in contact with the moulding surfaces. The induction heating technique is particularly suitable for providing a solution to these needs.

Document EP1924415 describes an induction heating device for the moulding cavity of a plastic injection mould, in which induction coils pass through the dies supporting the moulding surfaces. However, the energy efficiency achieved during use of a mould composed of an aluminium alloy, a situation that frequently occurs in plastic injection, requires the installation of high electrical power.

Document EP2861399 describes a method and a device for preheating a plastic injection mould. Said device comprises essentially two heating means to heat the moulding faces of the cavity as directly as possible. In this device according to prior art, one of the moulding surfaces is heated by putting the matrix supporting said moulding face in front of an electrically conducting core from which it is electrically isolated such that the moulding surface of said matrix forms one of the faces of an air gap with said core. The core and die assembly is placed inside an induction circuit. The moulding surface is heated by the circulation of currents induced on the faces of the air gap. The other moulding surface, supported by the other die forming the mould, is heated by radiation or by conduction by bringing it into contact with or facing a previously heated core. This solution according to prior art requires that the mould is sufficiently open so that the core can be inserted between the two dies. In all cases, it is no more than a preheating solution, that cannot be used to regulate the temperature of the moulding cavity once the cavity has been closed.

These solutions according to prior art are satisfactory; however they require high power electrical installations, the power necessary to heat one of the dies currently being of the order of 100 kW. When the manufacturing site comprises several installations of this type, the power of the corresponding electrical installation becomes a disadvantage.

Document DE102014114772 describes a plastic injection mould in which a very local zone is heated by bringing a heated element close to the moulding cavity, of which the wall thickness is reduced in the application zone of this element, particularly in order to eliminate the burr at the mould joint plane. Thus, this device only heats the zone considered after the moulded part is cooled, or during cooling, to separate the burr from the remainder of the part.

The invention aims to overcome the disadvantages of prior art and to achieve this relates to a mould, particularly for injection moulding, comprising:

a. a shell defining a cavity delimiting a moulding surface;

b. a heat accumulator;

c. induction heating means, configured to heat the heat accumulator;

d. comprising means to expose and hide a part of the surface of the shell, called a receiving surface, other than the moulding surface, to heat the heat accumulator or to hide it from this heat, so as to bring the entire moulding surface to an appropriate temperature for injection of material into said cavity.

Thus, after heating the heat accumulator to an appropriate temperature, it is simply held at this temperature, which requires less power.

The invention is advantageously used according to the embodiments presented below, that can be considered individually or in any technically feasible combination.

Advantageously, the shell comprises a circuit for the circulation of a heat transporting fluid with a view to cooling the moulding surface. Thus, the mould disclosed by the invention makes use of forced cooling of the moulding cavity without affecting the temperature of the heat accumulator.

According to one variant embodiment, the heat accumulator is a graphite block. In particular, this embodiment makes it possible to give priority to heating of the shell by radiation.

According to another variant embodiment, compatible with the above embodiment, the heat accumulator comprises a phase change material. This embodiment makes it possible to store thermal energy in the latent phase change heat of said material.

The invention also relates to a method of heating the surface of a mould in any one of the embodiments of the invention, said method comprising steps consisting of:

i. heating the heat accumulator;

ii. exposing the shell to heat from the heat accumulator;

iii. injecting material into the cavity after step ii).

Advantageously, step ii) includes heating of the heat accumulator. In particular, the temperature of the moulding cavity can be regulated in this embodiment.

According to one embodiment, step ii) is done by displacing the shell to face the heat accumulator. Thus, the heat accumulator at high temperature remains fixed. In particular, with this embodiment several moulds can be exposed to a pendular cycle, one of the moulds being heated while another is cooling, while limiting the installed power to the power necessary for heating a single heat accumulator.

According to this embodiment, the heat transfer from the heat accumulator to the shell is preferably achieved by radiation.

Furthermore, part of the heat transfer from the heat accumulator to the shell is by forced convection of a gas. Thus, heat transfer is faster.

According to another embodiment, step ii) is done by bringing the heat accumulator into contact with a surface of the shell. This embodiment is more particularly, but not exclusively, adapted to the fabrication of a mould with standalone heating, benefiting from the advantages of the invention.

According to the latter embodiment, step ii) is done by thermal expansion and the heat accumulator. Thus, exposure of the receiving surface of the shell does not require the use of a displacement mechanism.

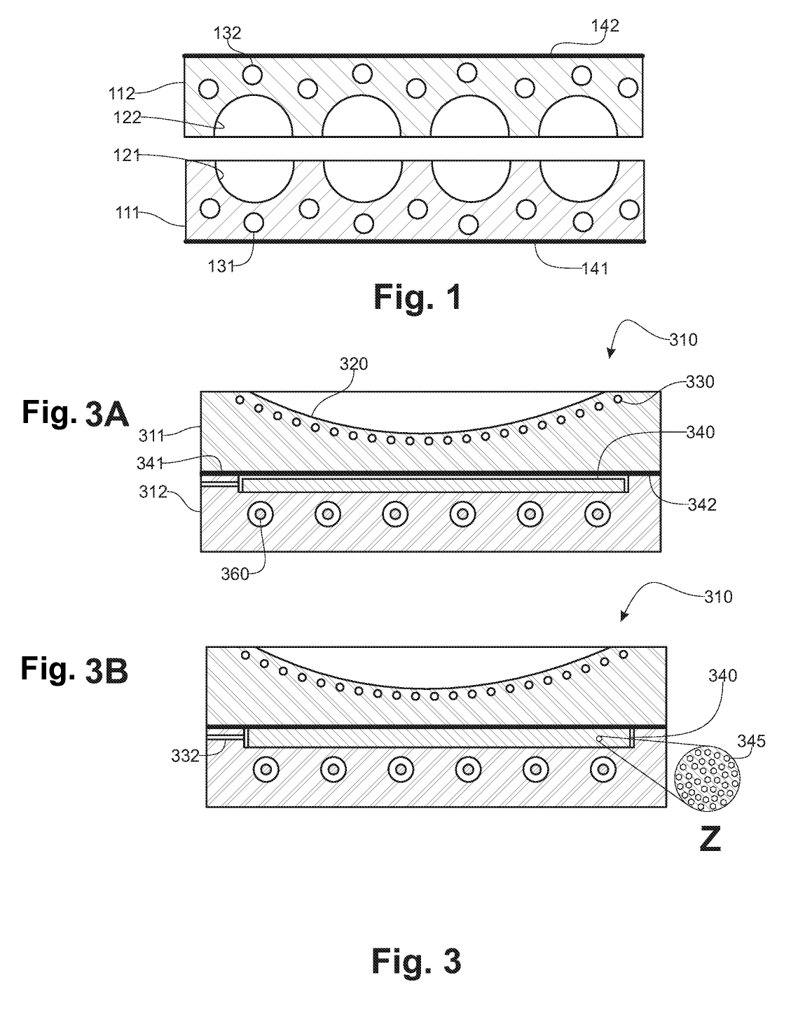

The invention is described below in its preferred embodiments, that are in no way limitative, with reference to FIGS. 1 to 4, wherein:

FIG. 1 is a sectional view representing the shells of a mould according to one example embodiment of the mould according to the invention;

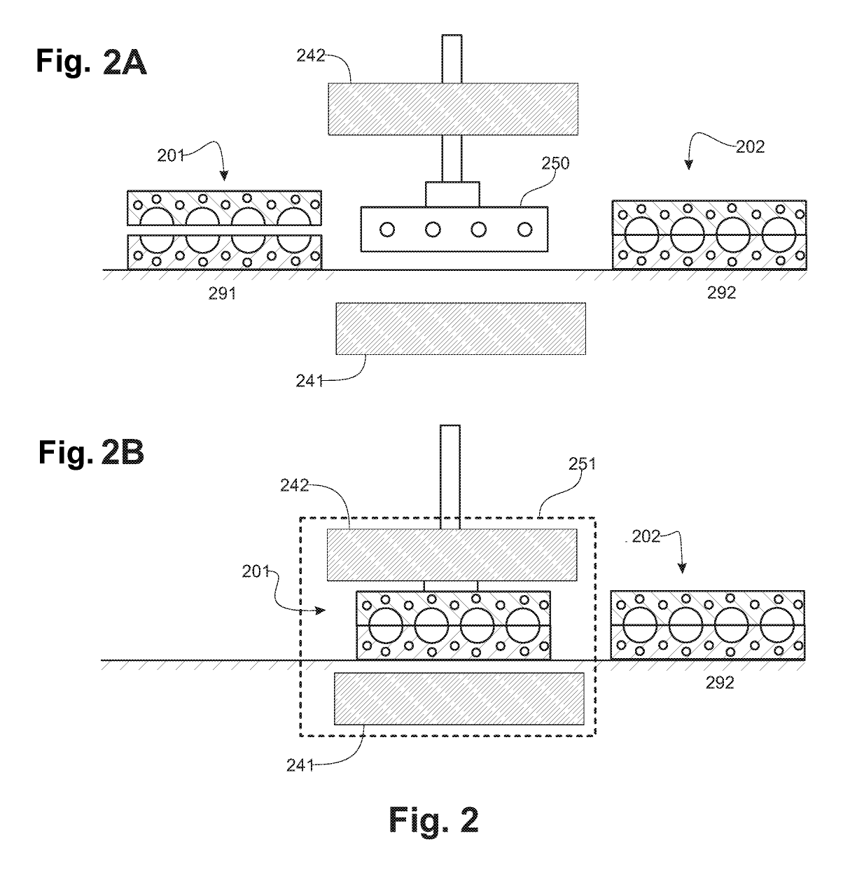

FIG. 2 diagrammatically illustrates an injection installation making use of the mould in FIG. 1, example embodiments with a pendular automation system are shown in FIGS. 2A and 2B;

FIG. 3 shows another example embodiment of a shell of a mould according to the invention, FIG. 3A outside the heating period of the moulding surfaces, and FIG. 3B during the heating period of the moulding surfaces; and

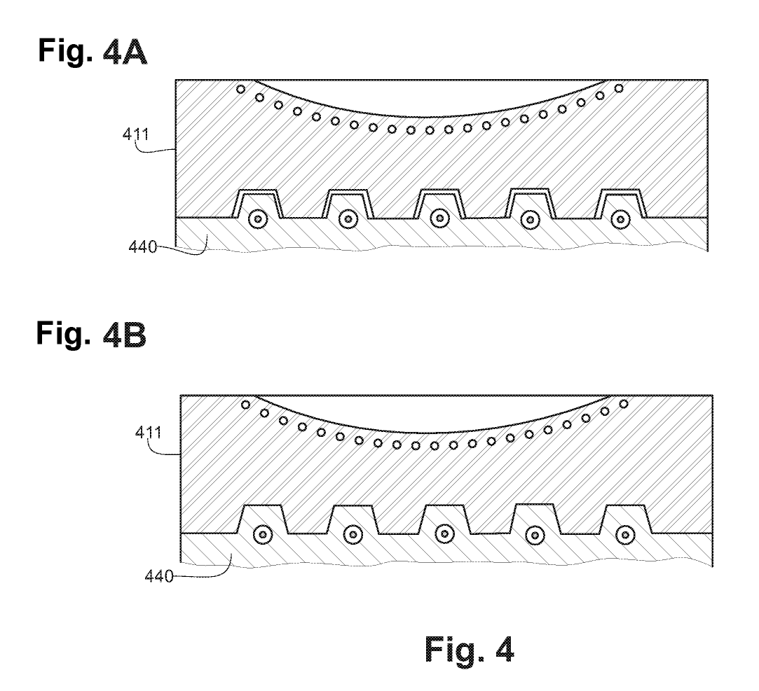

FIG. 4 is a partial view representing a variant embodiment of the shell in FIG. 3, FIG. 4A outside the heating period of the moulding surfaces, and FIG. 4B during the heating period of the moulding surfaces.

FIG. 1, according to one embodiment, the mould according to the invention comprises 2 shells (111, 112) each carrying a plurality of die cavities (121, 122) each die cavity corresponding to the moulding surfaces to make a part by injection of material into the closed cavity composed of each pair (121, 122) of die cavities when the two shells (111, 112) are brought into contact with each other, in other words when the mould is closed. Said shells are composed of a heat conducting material, preferably a metallic material such as an aluminium alloy or a tooling steel. Each half-shell performs a structure function to resist the injection pressure without deformation of the moulding surfaces, so that their thickness is sized accordingly. According to this example embodiment, each shell comprises conduits (131, 132) for circulation of a heat transporting fluid in the liquid or gas phase, used to cool said shell and more particularly the moulding surfaces and the material in contact with them. Advantageously, said conduits (131, 132) comprise turbulators (not shown) to improve convection exchanges between the heat transporting fluid and the shell.

According to this embodiment, each shell (111, 112) comprises a surface area called the receiving surface (141, 142), opposite the die cavities according to this example embodiment. Still according to this embodiment, the receiving surface comprises a coating giving priority to absorption of infrared radiation. As non-limitative examples said coating is composed of amorphous carbon deposited by “Physical Vapour Deposition” (PVD) on said receiving surface, or is obtained by chemical treatment called burnishing of this surface, or by electrochemical deposition of black chrome plating. Exposure of the reception surface of each half-shell to heat from the accumulator, either by conduction, radiation, convection or a combination of these heat transfer modes, can increase the temperature of the die cavities to a temperature suitable for injection of the moulded material, to assure that the cavity dies are uniformly and completely filled. Transmission of heat from the receiving surfaces (141, 142) to the moulding surfaces (121, 122) takes place by conduction in the thickness of the half-shells, which assures uniform distribution of the temperature on the moulding surfaces and prevents any appearance defect on the parts obtained using the mould according to the invention.

FIG. 2A, according to one example installation using the mould according to the invention, said installation comprises for example 2 moulds (201, 202) used alternately according to a pendular automation system. To achieve this, said installation comprises 2 unloading stations (291, 292), one injection station comprising an injection head (250) capable of injecting plastic material into the mould cavities (201,202). The installation also comprises a mechanism (not shown) to transfer the moulds (201, 202) from their loading station to their injection station. Alternatively, the installation comprises more than two unloading stations placed on a carrousel.

The injection station comprises two heat accumulators (241, 242) composed for example of graphite blocks. According to a first example embodiment, each heat accumulator is heated by an induction circuit, for example by placing each of them inside a turn along which a high frequency alternating current passes, for example between 10 kHz and 100 kHz, so as to increase their temperature for example to a temperature of between 700° C. and 1200° C.

Alternatively, the heat accumulators (241, 242) are composed of a ferromagnetic material and comprise a coating to improve their thermal emissivity on at least one of their faces.

According to one alternative embodiment of the induction circuit, the heat accumulators (241, 242) are heated by induction coils placed in tubes inside said accumulators.

FIG. 2B, according to one example embodiment with a pendular automation system, when one of the moulds (201) is in the injection station, the other mould (202) is in its unloading station (292). When it reaches the injection station, the mould (201) is subjected to radiation from the heat accumulators (241, 242) on its receiving surfaces. For example, the heat flux emitted by radiation by a graphite heat accumulator heated to 1000° C. reaches values of the order of 150×10³ W·m′². Advantageously, a device (not shown) can be used to blow a gas heated by contact with said heat accumulators (241, 242) onto the mould to cause a heat exchange by forced convection with the mould surfaces. Advantageously, the injection station comprises a chamber (251) filled with a neutral gas preserving the mould and oxidation heat accumulators.

Under such a heat flux, the mould (201) heats quickly until the temperature suitable for injection is reached in its moulding cavities. Injection is then made. Once injection has been done, the mould (201) is transferred from the injection station to the unloading station which has the effect of bringing the other mould (202) into the injection station and subjecting it to radiation from the heat accumulators. The unloading station advantageously comprises means of circulating a heat transporting fluid in the conduits of the mould, so as to accelerate its cooling. Said heat transporting fluid may for example be water, oil, or a gas. According to one embodiment, said heat transporting fluid circulates in a closed circuit comprising a cooling unit.

After the initial heating phase of the heat accumulators (241, 242), that is done over a sufficiently long period to limit the power demand, the energy consumed corresponds to maintaining the temperature of said heat accumulators which requires a smaller power demand than direct heating of the cold mould by induction. The use of induction for heating heat accumulators can nevertheless provide continued heating for the accumulators when they transfer their heat to the mould by radiation, convection or conduction.

FIG. 3A, according to another embodiment of a half-shell (310) of a mould according to the invention, it comprises two parts (311, 312) for example composed of an aluminium alloy. One of the two parts (311) carries a die cavity (320) forming a moulding surface, and conduits (330) for circulation of a heat transporting fluid for cooling of said moulding surface. Said first part (311) comprises a receiving surface (341).

The second part (312) of the half-shell, fixed to the first part, comprises pipes inside which induction coils (360) extend. According to one particular embodiment, said second part is composed of a non-metallic refractory material, for example a ceramic or a concrete, transparent to the magnetic field. The induction coils are for example composed of copper tubes or braids of copper wires. They make an induction circuit. A heat accumulator (340) is inserted between the two parts (311, 312) of the half-shell. Said heat accumulator is for example composed of a ferromagnetic steel with a high Curie point, for example an alloy based on iron (Fe) and silicon (Si) or iron (Fe) and cobalt (Co). It is preferably thermally isolated from the second part (312) of the half-shell. Said induction coils (360) are connected to a high frequency generator (not represented).

When it is heated by the induction coils (360) to a temperature called the holding temperature, said accumulator does not come into contact with the receiving surface (341) of the first part (311) of the shell. The contact resistance between the accumulator (340) and the receiving surface is high and heat transfer between the heat accumulator (340) and the part (311) of the shell carrying the die cavity (320) is lower.

FIG. 3B, in order to heat the first part of the half-shell, the temperature of the heat accumulator is increased by means of induction coils, said accumulator expands and then comes into intimate contact with the receiving surface (341). The contact resistance drops, and the heat accumulator transmits its heat to the part (311) of the half-shell carrying the die cavity (320). Advantageously, the receiving surface (341) of the first part of the shell comprises an interface layer (342), composed of a thin sheet made of a malleable or compressible heat conducting material, soldered or welded onto the receiving surface. As non-limitative examples, said sheet is composed of copper or an alloy of copper, nickel or graphite. Thus, the entry into contact of the heat accumulator (340) with said foil deforms the foil so as to compensate for the small shape differences between the heat accumulator and the receiving surface, and to provide optimal heat transfer between the two. Thus, the heat accumulator is held at a holding temperature equal to 50° C. to 100° C. below its temperature in the heating phase. Holding this temperature requires the use of lower electrical power and the power increase necessary during the heating phase is also lower due to preheating of the accumulator.

Said heat accumulator (340) does not perform any structural function in the mould. Its composition is thus chosen to optimise its response to induction heating and its ability to transfer its heat to the first part (311) of the half-shell and then to the moulding surface. According to one particular embodiment, detail Z, said accumulator has a cellular structure, each cell (345) being filled with a phase change material with a latent heat of transition. Advantageously, the phase change material is chosen such that its transition temperature is close to the holding temperature of the heat accumulator. For example, if the holding temperature is of the order of 200° C., the phase change material may for example be an organic material such as a polyol. If the holding temperature is higher, for example of the order of 400° C. or more, the phase change material may for example be a salt. According to these examples, the phase change material changes phase from the solid phase at low temperature to the liquid state at a higher temperature, absorbing latent heat of transition. In changing from the high temperature phase to the low temperature phase, the phase change material solidifies and restores said latent heat of transition. The combination of the cellular structure and the presence of a phase change material can increase the apparent thermal inertia of the heat accumulator (340) while holding it at the holding temperature, while maintaining a capability of fast heating up to the heating temperature.

The die cavity is cooled by circulation of the heat transporting fluid in the conduits (330) in the first part (311) of the shell. Advantageously, the second part (312) of the shell comprises channels (332) for conveyance of a heat transporting fluid around the heat accumulator (340) so as to accelerate its cooling to its holding temperature after the heating and temperature holding phase of the die cavity (320).

FIG. 4 according to one variant of the embodiment represented in FIG. 3, the interface between the first part (411) of the shell and the heat accumulator (440) is not plane but has complementary profiles. This embodiment can increase the potential contact surface between said first part (411) of the shell carrying the die cavity, and the heat accumulator (440). FIG. 4A outside the heating period of the first part (411), the two profiles are discontinuous at the receiving surface. FIG. 4B, in the heating situation, thermal expansion of the heat accumulator (440) due to its temperature rise brings its profile into contact with the receiving surface of the first part (411) of the shell thus reducing the thermal contact resistance between the two and facilitating heat transfer by conduction.

The above description and example embodiments show that the invention achieves the stated purpose, making it possible to benefit from the advantages of induction heating to heat the moulding cavity of a mould, composed of a non-ferromagnetic material, for example an aluminium alloy, while reducing the power demand necessary for this heating and thus maintaining reasonable sizing of the electrical power supply circuit.

1-11. (canceled)

12. A mold, particularly for injection molding, comprising:
a shell defining a cavity delimiting a molding surface;
a heat accumulator;
induction heating coils configured to heat the heat accumulator; and
a receiving surface, which is a part of a surface of the shell other than the molding surface, either exposed to or shielded from the heat of the heat accumulator, to bring the molding surface to a predetermined temperature to inject a material into the cavity.

13. The mold according to claim 12, wherein the shell comprises a circuit to circulate a heat transporting fluid to cool the molding surface.

14. The mold according to claim 12, wherein the heat accumulator is a graphite block.

15. The mold according to claim 12, wherein the heat accumulator comprises a phase change material.

16. The mold according to claim 15, wherein the heat accumulator thermally expands to bring the heat accumulator in contact with and transmit the heat to the receiving surface.

17. The mold according to claim 12, wherein the shell is displaced from the heat accumulator to shield the receiving surface from the heat of the heat accumulator.

18. A method for heating the surface of a mold according to claim 12, comprising steps of:
heating the heat accumulator;
exposing the shell to the heat from the heat accumulator, to bring the molding surface to the predetermined temperature for injection; and
injecting the material into the cavity after the molding surface has reached the predetermined temperature for injection.

19. The method according to claim 18, wherein the heat accumulator is heated while the shell is exposed to the heat from the heat accumulator.

20. The method according to claim 18, wherein the shell is exposed to the heat by displacing the shell to face the heat accumulator.

21. The method according to claim 20, wherein the heat is transferred from the heat accumulator to the shell by radiation.

22. The Method according to claim 21, wherein heat is transferred partly from the heat accumulator to the shell by forced convection of a gas.

23. The method according to claim 18, wherein step the shell is exposed to the heat from the heat accumulator by bringing the heat accumulator into contact with a surface of the shell.

24. The method according to claim 23, wherein the heat accumulator thermally expands to contact the surface of the shell.
